(19) United States
(12) Patent Application Publication
(10) Pub. No.: US 2026/0093612 A1
(43) Pub. Date: Apr. 2, 2026

(54) DATA ANOMALY GENERATION

(71) Applicant: Capital One Services, LLC, McLean, VA (US)

(72) Inventors: Shitij KULSHRESHTHA, Glen Allen, VA (US); Rama Mohan BOPPANA, Glen Allen, VA (US); Andrew SEATON, Chesterfield, VA (US)

(21) Appl. No.: 18/903,351

(22) Filed: Oct. 1, 2024

(51) Int. Cl. G06F 11/36

(52) U.S. Cl. CPC G06F 11/3692

(57) ABSTRACT

In some implementations, a data anomaly generation system may receive a data anomaly configuration. The data anomaly generation system may output, based on the data anomaly configuration, an output dataset comprising one or more data anomalies.

### BACKGROUND

In software development, chaos engineering is the discipline of experimenting on the resilience of a software system. For example, chaos engineering may involve intentionally introducing faults into the software system to test the resilience.

### SUMMARY

Some implementations described herein relate to a system for data anomaly generation. The system may include one or more memories and one or more processors communicatively coupled to the one or more memories. The one or more processors may be configured to receive a data anomaly configuration. The one or more processors may be configured to receive an input dataset. The one or more processors may be configured to output, based on the data anomaly configuration and the input dataset, an output test dataset comprising one or more data anomalies.

Some implementations described herein relate to a method of data anomaly generation. The method may include receiving a data anomaly configuration. The method may include outputting, based on the data anomaly configuration, an output dataset comprising one or more data anomalies.

Some implementations described herein relate to a non-transitory computer-readable medium that stores a set of instructions. The set of instructions may include one or more instructions that, when executed by one or more processors of a device, cause the device to receive a data anomaly configuration. The set of instructions may include one or more instructions that, when executed by one or more processors of the device, cause the device to output, based on the data anomaly configuration, an output test dataset comprising one or more data anomalies.

### BRIEF DESCRIPTION OF THE DRAWINGS

FIG. 1 is a diagram of an example associated with data anomaly generation, in accordance with some embodiments of the present disclosure.

FIG. 2 is a diagram of an example associated with a command line interface (CLI) tool, in accordance with some embodiments of the present disclosure.

FIG. 3 is a diagram of an example associated with a high-level design for data anomaly generation, in accordance with some embodiments of the present disclosure.

FIG. 4 is a diagram of an example associated with release pipeline integration of data anomaly generation, in accordance with some embodiments of the present disclosure.

FIG. 5 is a diagram of an example associated with a use case for data anomaly generation, in accordance with some embodiments of the present disclosure.

FIG. 6 is a diagram of examples associated with output dataset generation, in accordance with some embodiments of the present disclosure.

FIG. 7 is a diagram of examples associated with the input dataset, in accordance with some embodiments of the present disclosure.

FIG. 8 is a diagram of an example environment in which systems and/or methods described herein may be implemented, in accordance with some embodiments of the present disclosure.

FIG. 9 is a diagram of example components of a device associated with data anomaly generation, in accordance with some embodiments of the present disclosure.

FIG. 10 is a flowchart of an example process associated with data anomaly generation, in accordance with some embodiments of the present disclosure.

### DETAILED DESCRIPTION

The following detailed description of example implementations refers to the accompanying drawings. The same reference numbers in different drawings may identify the same or similar elements.

The functionality of a software system can be tested by providing test data to the software system and monitoring the performance of the software system based on the test data. However, the test data may not include certain data anomalies that the software system might encounter after the testing. Examples of data anomalies that the software system encounter after testing may comprise mismatches between the data and a schema (e.g., a database schema, which refers to how data is structured within a database), schema drift (e.g., where a database schema differs from a reference database schema due to software bugs, human error, or the like), out-of-range data that violates schema-declared constraints, or the like. Data that does not match the schema may have an incorrect type, missing data in required columns, missing or incorrect padding, or the like. Schema drift anomalies may be caused by new columns that appear partway through a dataset or file, columns that disappear partway through a dataset or file, a type of data in a column changing, character-encoding changes, or the like. Out-of-range data anomalies may include numerical range violations, strings violating a specified format, strings outside a declared enumeration, data format violations, improperly formatted records, changes to data in join keys causing a key breakage, or the like. Lack of exposure to such data anomalies during testing may lead to poor performance when the software system later encounters those data anomalies.

Some implementations described herein enable configuration of data anomalies in an output test dataset. The data anomaly configuration may configure various data anomaly parameters for an output test dataset. A data anomaly generation system (e.g., a data chaos generator) may, based on the data anomaly configuration, provide an output test dataset that contains the configured data anomalies. In some aspects, the data anomaly generation system may receive an input dataset that does not contain the data anomalies and may insert the data anomalies into the input dataset. In other aspects, the data anomaly generation system may generate an output test dataset without an input dataset. In either case, the output test dataset may include the configurable data anomalies.

As a result, the data anomaly generation system may introduce various types of configurable data chaos (e.g., anomalies), thereby improving performance of software systems after testing. For example, the data anomaly configuration may help to improve regression testing of new deployments, expand coverage of edge case testing, stress-test tooling and data pipelines by introducing changes that are not known a priori, or the like. In some cases, the data anomaly generation system may use data chaos to drive dataset changes for testing, such as schema drifts (e.g., schema drifts over time), partition key changes, dirty data location, or the like. Thus, software systems may be correctly tested (e.g., during regression tests of a latest build) for expected cases and edge cases to verify robustness, reliability, and/or stability of the latest deployable code for release. For example, the data anomaly generation system may assist with regression tests for each deployment (for example, a software build may be terminated in case of test failures), simulate chaos to detect the robustness of a pipeline, assist data pipeline owners in testing for edge cases with “dirty” data, or the like.

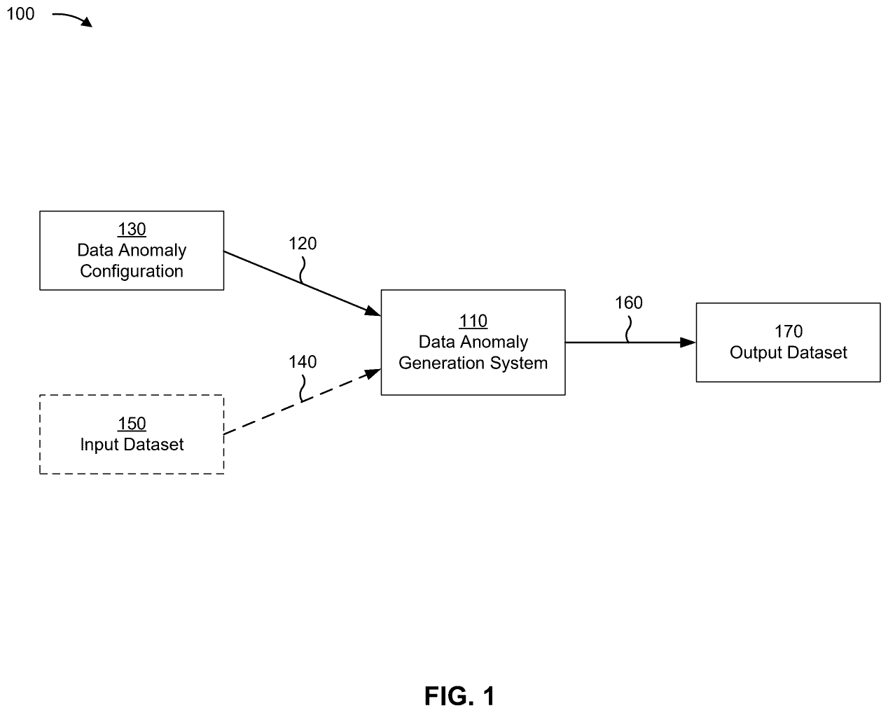

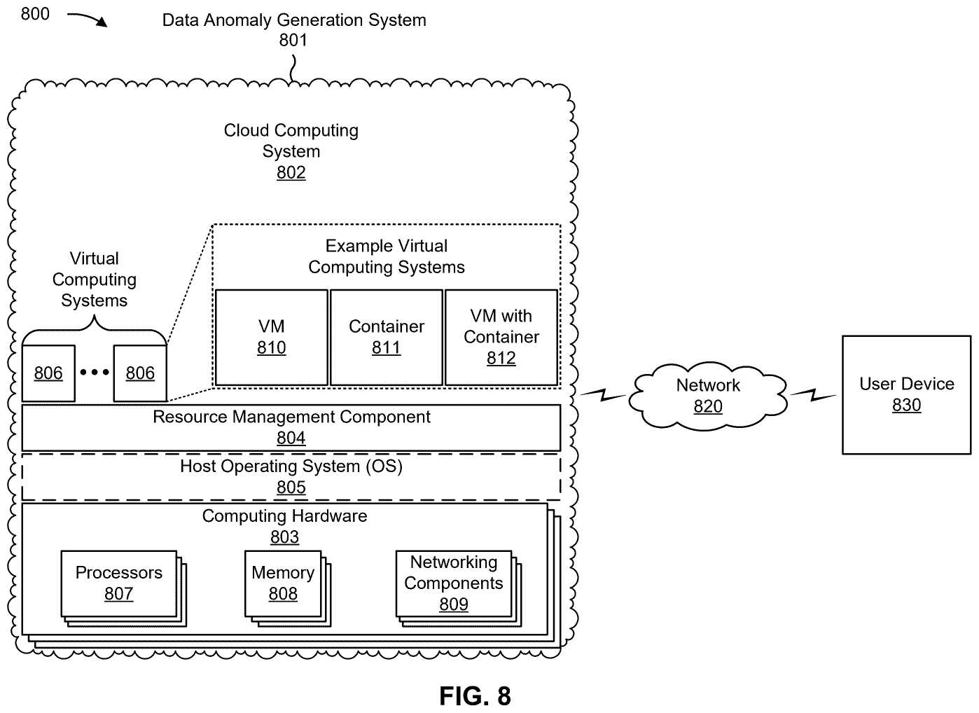

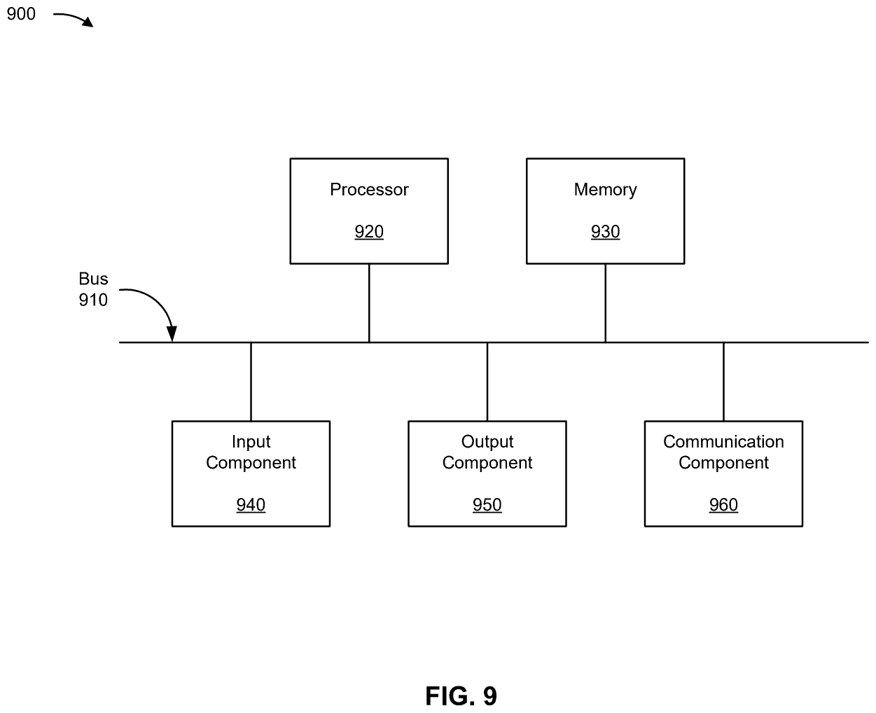

FIG. 1 is a diagram of an example 100 associated with data anomaly generation. As shown in FIG. 1, example 100 includes a data anomaly generation system 110. The data anomaly generation system 110 is described in more detail in connection with FIGS. 8 and 9.

As shown by reference number 120, the data anomaly generation system 110 may receive a data anomaly configuration 130. For example, the data anomaly configuration 130 may comprise a configuration file. In some aspects, the data anomaly configuration 130 may configure one or more data anomaly parameters. For example, the data anomaly configuration 130 may configure introduction of one or more data anomalies into output data (e.g., the data anomaly parameters may control the introduction of the data anomalies into the output data). For example, the data anomaly configuration 130 may configure adding a column to a source dataset and/or control which columns in the source dataset are to be modified. Additionally, or alternatively, the data anomaly configuration 130 may configure source data, a schema location (e.g., a catalog of registered schema or a local schema location), a location for output data, or the like.

In some aspects, the data anomaly configuration 130 may comprise a data anomaly selection configuration. For example, the data anomaly selection configuration may configure the data anomaly generation system 110 to select one or more feature modules (e.g., generator modules) that correspond to different types of data anomalies. The selection of the one or more feature modules may be user-defined, weighted, random, or the like.

In some aspects, the data anomaly configuration may be based on one or more generative artificial intelligence (AI) prompts. For example, a user may input the one or more generative AI prompts, which may trigger a generative AI system to output the data anomaly configuration. For example, one or more generative AI prompts may include conversational language that describes target data anomalies to configure for inclusion in the output data, and the generative AI system may generate the data anomaly configuration accordingly. For example, the generative AI system may generate a machine-readable data anomaly configuration file that comprises the data anomaly configuration. Additionally, or alternatively, the generative AI system may generate a schema (e.g., based on the one or more generative AI prompts) for data generation. In some examples, the generative AI system may be a plug-in to the data anomaly generation system.

As shown by reference number 140, the data anomaly generation system 110 may receive an input dataset 150. The input dataset 150 may comprise a source dataset that contains source data. In some examples, the input dataset 150 may be prepared externally to the data anomaly generation system 110.

As shown by reference number 160, the data anomaly generation system 110 may output, based on the data anomaly configuration 130, an output dataset 170 comprising one or more data anomalies. For example, the output dataset 170 (e.g., a test dataset) may include output data that contains the one or more data anomalies according to the data anomaly configuration 130 (and/or other factors, such as boundary conditions). For example, the data anomaly parameter(s) configured by the data anomaly configuration 120 (e.g., data anomaly parameter(s) of the output dataset 170) may control how the data anomaly generation system 110 introduces the one or more data anomalies into the output dataset 170. In some examples, the data anomaly generation system 110 may introduce, in the output dataset 170, schema-level anomalies, such as schema drift (e.g., schema drift over time), partition key changes, or the like. For example, the data anomaly generation system 110 may introduce schema drift by using a local schema to override a catalog schema definition. In some examples, the data anomaly generation system 110 may introduce data chaos in the output dataset 170 by generating column-level anomalies, such as by adding a new column in the output dataset 170. The output dataset 170 may comprise any suitable file format, such as a delimited file type containing character delimited text, a column-oriented data file format, or the like. Additionally, or alternatively, the output dataset 170 may contain complex fields (e.g., records).

In some aspects, the output dataset 170 may comprise an output test dataset. For example, the output test dataset may comprise test input data for a software system. For example, the output test dataset may be used for model testing, unit and/or end-to-end testing for edge cases, regressions testing, legacy dataset migration testing, or the like.

In some aspects, the data anomaly generation system 110 may output the output dataset 170 based on the input dataset 150. For example, the data anomaly generation system 110 may produce the output dataset 170 by modifying the input dataset 150. For example, the data anomaly generation system 110 may randomly, deterministically, or probabilistically select for modification columns, data types, partition keys, or the like.

In some aspects, the data anomaly generation system 110 may output the output dataset 170 by generating the output dataset 170. For example, the data anomaly generation system 110 may produce the output dataset 170 without using the input dataset 150. For example, the data anomaly generation system 110 may generate a set of random data as per the relevant schema definition (e.g., using one or more anomaly generator classes), and include the set of random data in the output dataset 170. In some examples, the data anomaly generation system 110 may comprise, or be integrated with, a synthetic data generator (e.g., the synthetic data generator may generate the set of random data).

In some aspects, the one or more data anomalies may include one or more data type anomalies. In some examples, the one or more data type anomalies may involve mismatches between a data type of a column of the output dataset 170 (e.g., as specified in a schema) and data contained within the column. In some examples, the data anomaly generation system 110 may create the mismatch by outputting the data contained within the column. For example, the data anomaly generation system 110 may generate the data in the column and/or replace data in the input dataset 150 with the data. In some examples, the data anomaly generation system 110 may create the mismatch by generating or coercing (e.g., converting) the data type of the column to one that does not match the data contained within the column. In some examples, the data anomaly generation system 110 may comprise a type violation generator that generates the one or more data type anomalies. In some examples, the type violation generator may generate the output dataset 170 with mismatching data types. In some examples, the type violation generator may change values in the input dataset 150 to produce the output dataset 170 with mismatching data types. Table 1 shows an example of an input dataset 150 with matching data types, and table 2 below shows an example of the output dataset 170 with mismatching data types.

TABLE 1

| Int | String |
|---|---|
| 12 | a |
| 5 | b |
| 54 | a |
| 78 | c |

TABLE 2

| Int | String |
|---|---|
| fed | 124 |
| abc | 3 |
| ABC | 12 |
| DEF | 9 |

In some aspects, the one or more data anomalies may include one or more data padding anomalies. In some examples, the one or more padding anomalies may involve addition or removal of padding. For example, the data anomaly configuration 130 may configure a padding length (e.g., a quantity of characters or spaces comprising the padding), a padding side (e.g., the side of the data on which the padding is included), or the like, and the data anomaly generation system 110 may generate the one or more data padding anomalies accordingly. In some examples, the data anomaly generation system 110 may remove padding from the input dataset 150 and re-pad the input dataset 150 with new values to generate the one or more data padding anomalies. In some examples, the data anomaly generation system 110 may comprise a padded or unpadded data generator that generates or removes padding from specified columns in the input dataset 150. For example, Table 3 shows an example with padding, and Table 4 shows an example without padding. In cases where Table 3 comprises the input dataset 150 and Table 4 comprises the output dataset 170, the unpadded data generator may convert Table 3 to Table 4 by unpadding the data in the input dataset 150. In cases where Table 4 comprises the input dataset 150 and Table 3 comprises the output dataset 170, the padded data generator may convert Table 4 to Table 3 by adding padding to the data in the input dataset 150.

TABLE 3

| | |
|---|---|
| 000001234 | _ _ _ _abc def |
| 000765432 | _abc defabc |
| 000111222 | _ _ _ _ _ _ _ _ _aa |

TABLE 4

| | |
|---|---|
| 1234 | abc def |
| 765432 | abc defabc |
| 111222 | aa |

In some aspects, the one or more data anomalies may include one or more data anomalies associated with one or more enumerated values. In some examples, the one or more enumerated values may include values (e.g., string values) in an enumerated list. The one or more data anomalies may be associated with the one or more enumerated values in that the data anomaly generation system 110 may generate the one or more data anomalies based on the one or more enumerated values. For example, the data anomaly configuration 130 may configure a probability of producing a value that is outside of the one or more enumerated values (e.g., a value that is not the one or more enumerated values) in any given row of the output dataset 170, and the data anomaly generation system 110 may generate the one or more data anomalies based on the configurable probability. The data anomaly generation system 110 may generate the one or more data anomalies with or without using a regular expression (regex) pattern. In some examples, the one or more data anomalies associated with the one or more enumerated values may be referred to as one or more enumerated data anomalies.

In some aspects, the one or more data anomalies may include one or more data anomalies associated with one or more value ranges. In some examples, the one or more value ranges may include numeric values. The one or more data anomalies may be associated with the one or more value ranges in that the data anomaly generation system 110 may generate the one or more data anomalies based on the one or more value ranges. For example, the data anomaly configuration 130 may configure a probability of producing a value that is outside of the one or more value ranges in any given row of the output dataset 170, and the data anomaly generation system 110 may generate the one or more data anomalies based on the configurable probability. For example, depending on the configured probability, the data anomaly generation system 110 may generate the one or more data anomalies comprising numeric values within and/or outside the one or more value ranges. For example, the data anomaly generation system 110 may produce the output dataset 170 that includes the one or more data anomalies using, or not using, the input dataset 150. The data anomaly generation system 110 may support any suitable numeric type(s) (e.g., as part of the input dataset 150 and/or the output dataset 170), such as integer numeric types, float numeric types, or the like. In some examples, the one or more data anomalies associated with the one or more value ranges may be referred to as one or more numeric range anomalies.

In some aspects, the one or more data anomalies may include one or more time zone data anomalies. For example, the data anomaly generation system 110 may add or remove time zone indications from the input dataset 150, generate random dates and/or times in a specified time zone, change the time zone specifier on a column (with or without changing literal data values), or the like.

In some aspects, the data anomaly generation system 110 may output the output dataset 170 based on the data anomaly selection configuration. For example, the data anomaly generation system 110 may select the one or more feature modules in accordance with the data anomaly selection configuration and produce the output dataset 170 based on the selection of the one or more feature modules.

In some aspects, the data anomaly generation system 110 may output the output dataset 170 based on a generative AI model. In some examples, the generative AI model may be a plug-in generative AI model for synthetic data creation (e.g., chaos generation). For example, the data anomaly generation system 110 may use the generative AI model to generate data (e.g., synthetic data) based on a regex pattern. The generative AI model may generate at least the one or more data anomalies based on a prompt (e.g., a user prompt). For example, the generative AI model may generate data anomalies in response to respective prompts. In some examples, the generative AI model may be trained on columns in the input dataset 150.

As indicated above, FIG. 1 is provided as an example. Other examples may differ from what is described with regard to FIG. 1.

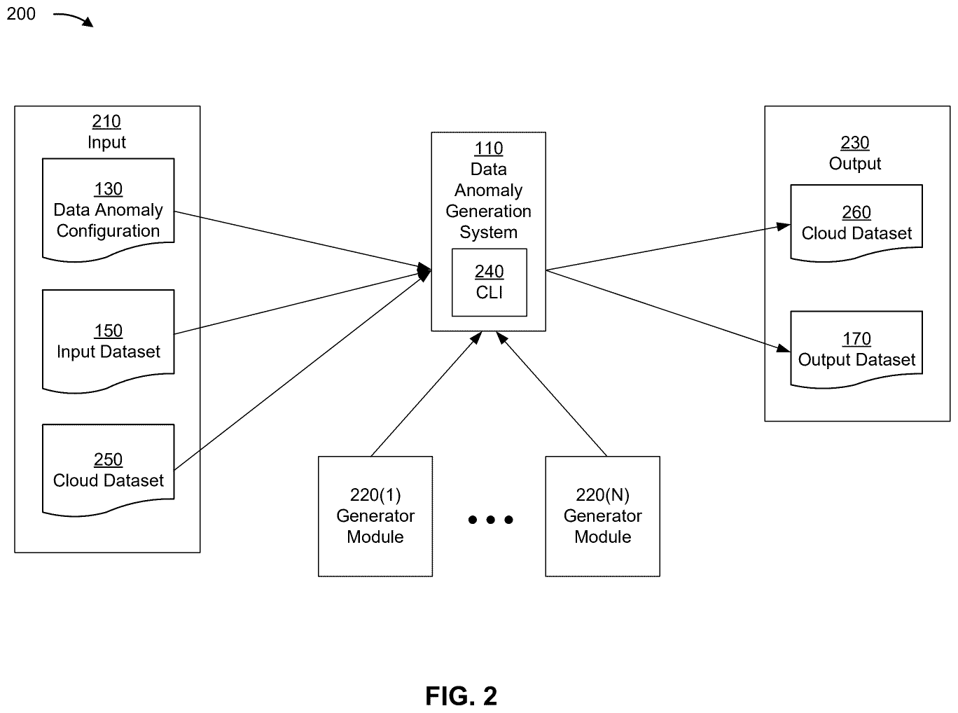

FIG. 2 is a diagram of an example 200 associated with a CLI tool. As shown in FIG. 2, example 200 includes the data anomaly generation system 110, a set of inputs 210, generator modules 220(1)-220(N), and a set of outputs 230. The data anomaly generation system 110 may include a CLI 240 that enables a user to interact with (e.g., input commands to and/or view output of) the data anomaly generation system 110. The set of inputs 210 may include the data anomaly configuration 130, the input dataset 150, and/or a cloud dataset 250. The set of outputs 230 may include the output dataset 170 and/or a cloud dataset 260.

In some examples, the data anomaly generation system 110 may read data from the input dataset 150 (e.g., stored locally to the data anomaly generation system 110) and/or the cloud dataset 250. Additionally, or alternatively, the data anomaly generation system 110 may write data to the output dataset 170 (e.g., stored locally to the data anomaly generation system 110) and/or the cloud dataset 260. In some examples, the data anomaly generation system 110 may read directly from the cloud dataset 250 and/or write files directly to the cloud dataset 260.

In some examples, the data anomaly generation system 110 may use the generator modules 220(1)-220(N) to produce the output 230. For example, the data anomaly configuration 130 may configure the data anomaly generation system 110 to select one or more of the generator modules 220(1)-220(N), which the data anomaly generation system 110 may use to introduce the one or more data anomalies (e.g., vertically or horizontally) to the output dataset 170 and/or the cloud dataset 260.

As indicated above, FIG. 2 is provided as an example. Other examples may differ from what is described with regard to FIG. 2.

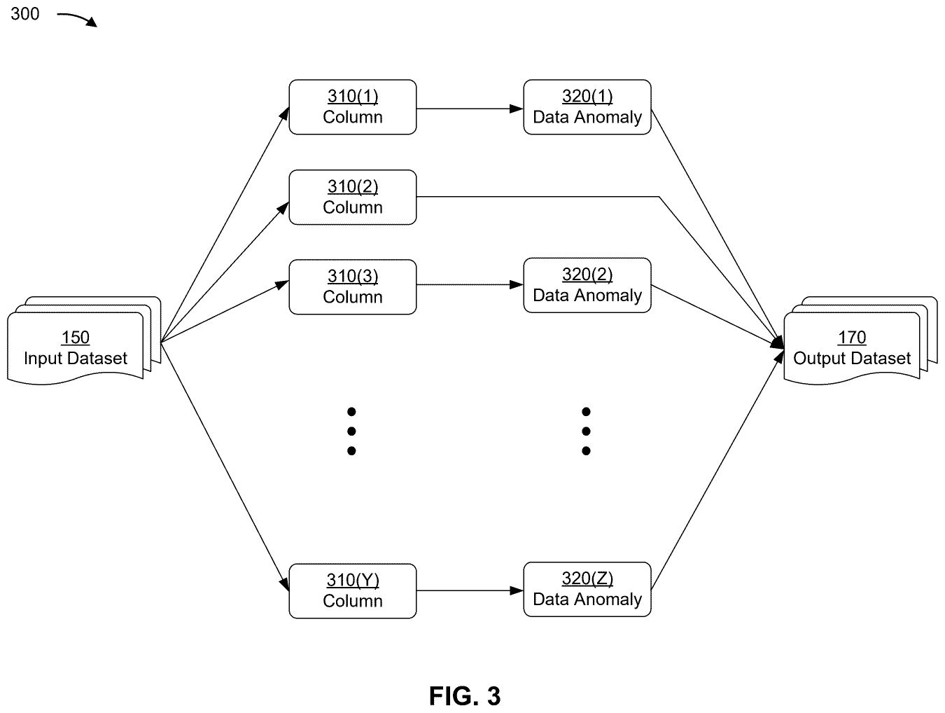

FIG. 3 is a diagram of an example 300 associated with a high-level design for data anomaly generation. In example 300, the input dataset 150 may include columns 310(1)-310(Y). The data anomaly generation system 110 may introduce one or more anomalies 320(1)-320(Z) (e.g., data anomalies) to one or more of the columns 310(1)-310(Y) to output the output dataset 170. For example, the output dataset 170 may include a data anomaly 320(1) in column 310(1), no configured data anomaly in column 310(2), a data anomaly 320(3) in column 310(3), and so forth.

As indicated above, FIG. 3 is provided as an example. Other examples may differ from what is described with regard to FIG. 3.

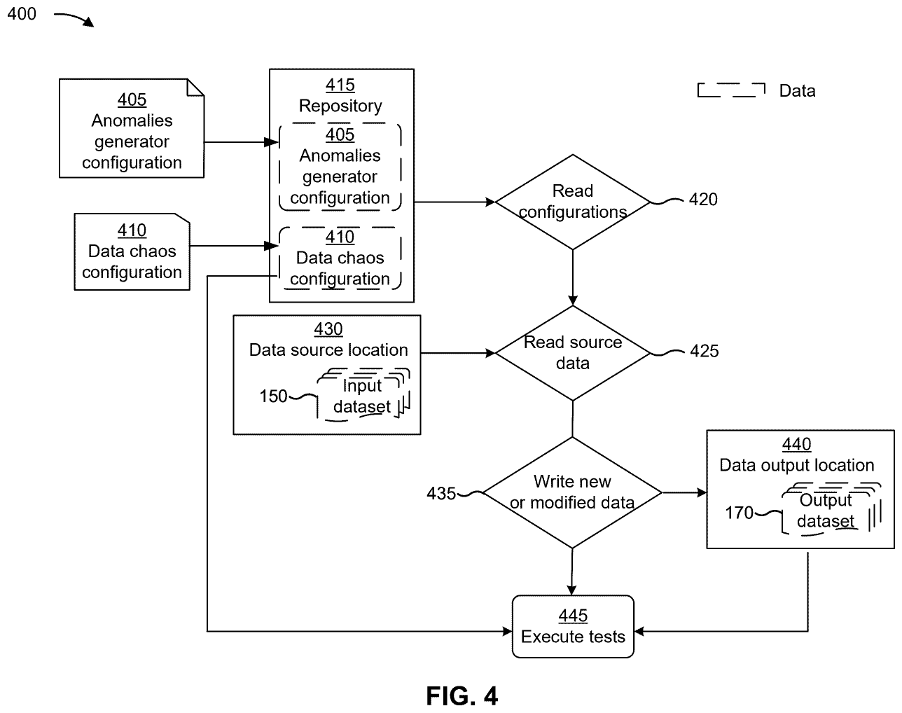

FIG. 4 is a diagram of an example 400 associated with release pipeline integration of data anomaly generation. As shown in FIG. 4, example 400 includes an anomalies generator configuration 405 (e.g., a test configuration) and a data chaos configuration 410. The anomalies generator configuration 405 and the data chaos configuration 410 may comprise the data anomaly configuration 130. For example, the anomalies generator configuration 405 may configure data generation based on a regex pattern, an absolute value, or the like. Additionally, or alternatively, the data chaos configuration 410 may be random, weighted, or user-defined (e.g., the data chaos configuration 410 may configure random, weighted, or user-defined selection of one or more feature modules). A repository 415 may store the anomalies generator configuration 405 and the data chaos configuration 410.

As shown by reference number 420, the data anomaly generation system 110 may read, from the repository 415, the anomalies generator configuration 405 and/or the data chaos configuration 410. As shown by reference number 425, the data anomaly generation system 110 may read, from a data source location 430, the input dataset 150. As shown by reference number 435, the data anomaly generation system 110 may write data (e.g., new or modified data) to the output dataset 170 in a data output location 440. As shown by reference number 445, a test may be executed on a software system using the data chaos configuration 410 and/or the output dataset 170.

As indicated above, FIG. 4 is provided as an example. Other examples may differ from what is described with regard to FIG. 4.

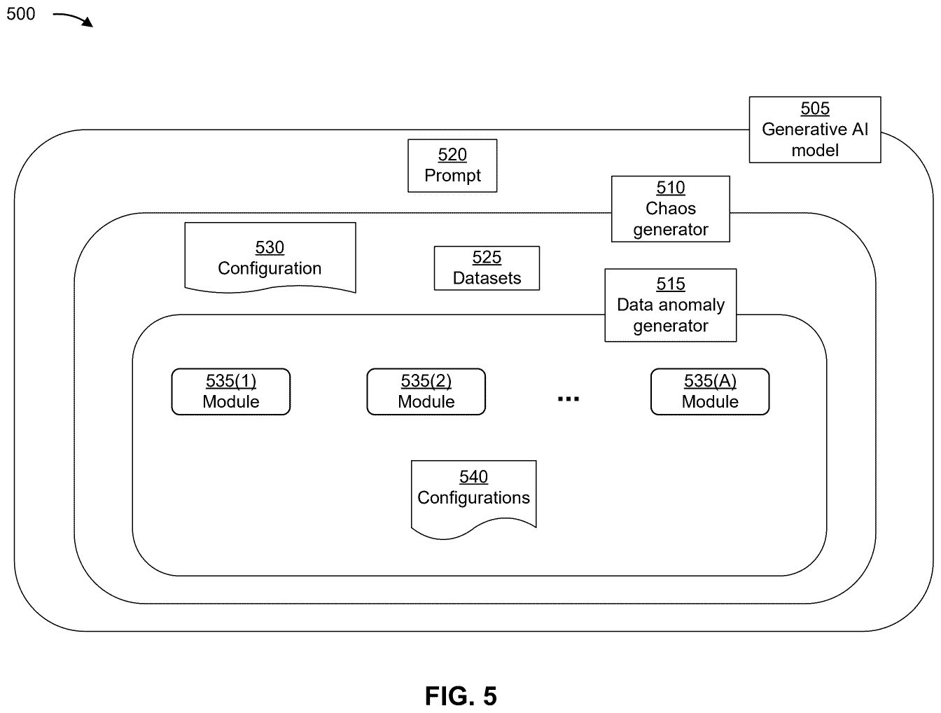

FIG. 5 is a diagram of an example 500 associated with a use case for data anomaly generation. As shown in FIG. 5, example 500 includes a generative AI model 505, a chaos generator 510, and a data anomaly generator 515 (e.g., a synthetic data generator). In some examples, the generative AI model 505, the chaos generator 510, and the data anomaly generator 515 may comprise the data anomaly generation system 110.

The generative AI model 505 may generate one or more prompts 520 (e.g., generative AI prompts). For example, the prompt(s) 520 may help to generate the data anomaly configuration 130 (e.g., a chaos configuration) based on one or more keywords. For example, the generative AI model 505 may enable a user to prepare the data anomaly configuration 130 for the chaos generator 510.

The chaos generator 510 may introduce one or more data anomalies into data (e.g., chaos generator 510 may introduce one or more data anomalies into the input dataset 150 to produce the output dataset 170). The chaos generator 510 may include one or more datasets 525 (e.g., the input dataset 150, the output dataset 170, or the like) and a configuration 530. The configuration 530 (e.g., a data anomaly selection configuration) may configure module selection. For example, the chaos generator 510 may select one or more modules 535(1)-535(A), discussed further below, in a weighted or random manner based on the configuration 530.

The data anomaly generator 515 may include the modules 535(1)-535(A) (e.g., feature modules) and one or more configurations 540, which may comprise dataset specifications (e.g., schema). In some examples, the data anomaly generator 515 may comprise a data anomaly library. For example, the data anomaly generator 515 may generate the data anomaly library, which may be containerized or application-pluggable. The data anomaly library may introduce data anomalies to “clean” data (e.g., data that is free of configured data anomalies, such as data in the input dataset 150) according to modules 535(1)-535(A), the configuration(s) 540, one or more rules toggled by a producer, or the like. Thus, the data anomaly generator 515 may introduce chaos to data. In some examples, the data anomaly generator 515 may input and/or output data files that are local to an execution environment.

As indicated above, FIG. 5 is provided as an example. Other examples may differ from what is described with regard to FIG. 5.

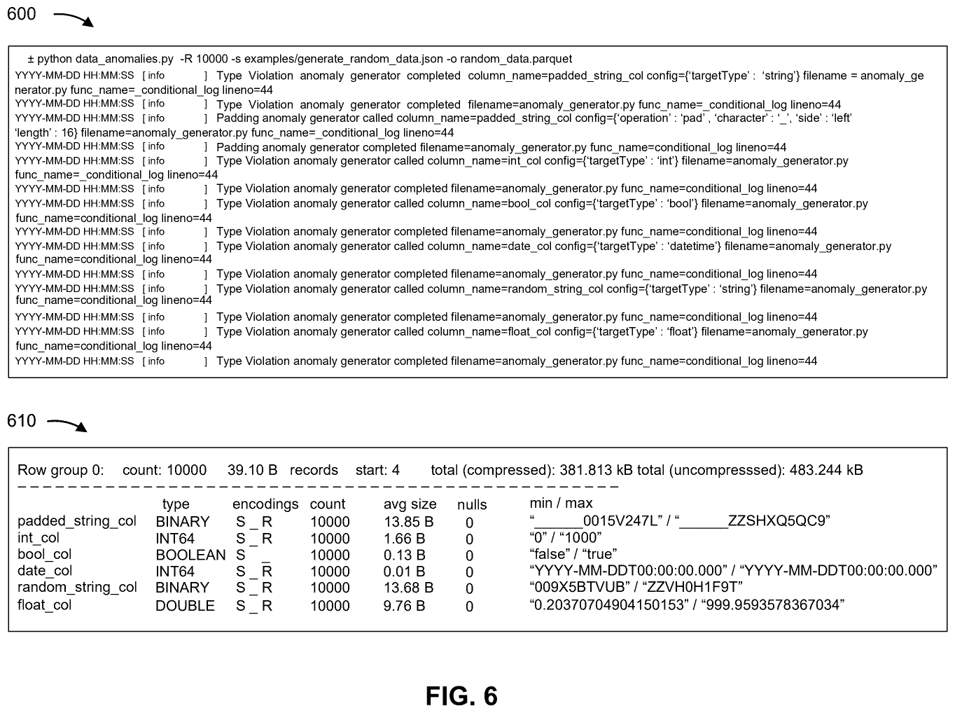

FIG. 6 is a diagram of examples 600 and 610 associated with output dataset generation. Example 600 shows a CLI displaying an indication the data anomaly generation system 110 generating the one or more data anomalies in the output dataset 170. For example, the data anomaly generation system 110 may generate new data with random values for a given schema (e.g., without the input dataset 150). Example 610 shows a CLI displaying an indication of output data of the data anomaly generation system 110. For example, the CLI may display a summary of data contained in the output dataset 170.

As indicated above, FIG. 6 is provided as an example. Other examples may differ from what is described with regard to FIG. 6.

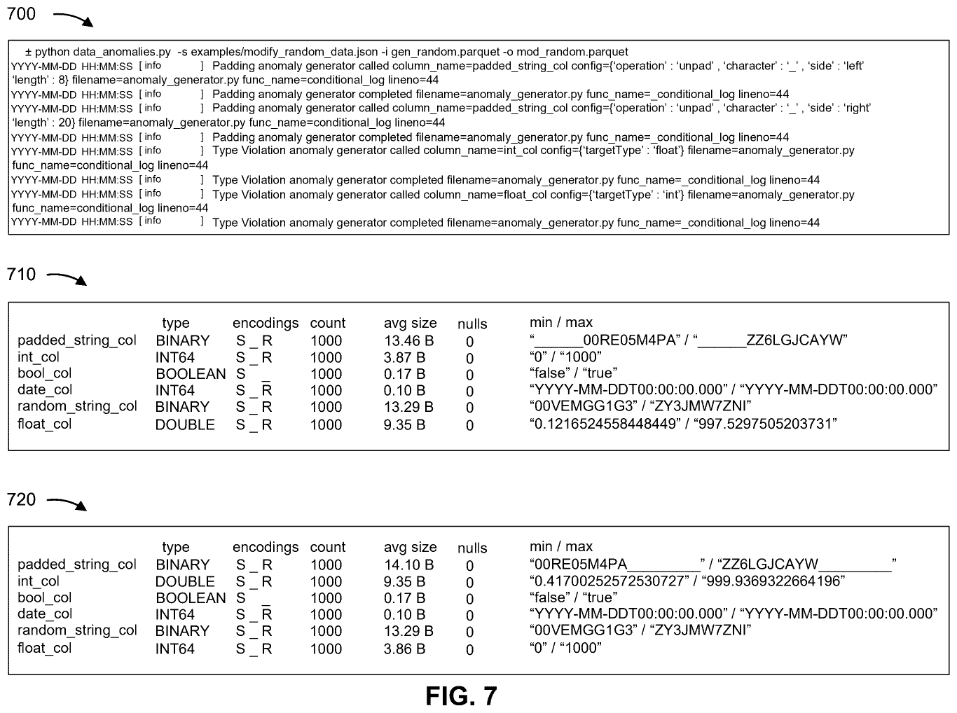

FIG. 7 is a diagram of examples 700-720 associated with the input dataset 150. Example 700 shows a CLI displaying an indication of the data anomaly generation system 110 generating the one or more data anomalies and introducing the one or more data anomalies to the input dataset 150. For example, the data anomaly generation system 110 may modify data in existing column(s) of the input dataset 150 (e.g., an input file). Example 710 shows a CLI displaying an indication of the input dataset 150. For example, the CLI may display a summary of data contained in the input dataset 150. Example 720 shows a CLI displaying an indication of the output dataset 170. For example, the CLI may display a summary of data contained in the output dataset 170.

As indicated above, FIG. 7 is provided as an example. Other examples may differ from what is described with regard to FIG. 7.

Outputting the output dataset 170 comprising the one or more data anomalies based on the data anomaly configuration 130 may enable the data anomaly generation system 110 to introduce various types of configurable data chaos (e.g., anomalies), thereby improving performance of software systems after testing. For example, the data anomaly configuration 130 may help to improve regression testing of new deployments, expand coverage of edge case testing, stress-test tooling and data pipelines by introducing changes that are not known a priori, or the like. In some cases, the data anomaly generation system 110 may use data chaos to drive dataset changes for testing, such as schema drifts (e.g., schema drifts over time), partition key changes, dirty data location, or the like. Thus, software systems may be correctly tested (e.g., during regression tests of a latest build) for expected cases and edge cases to verify robustness, reliability, and/or stability of the latest deployable code for release. For example, the data anomaly generation system 110 may assist with regression tests for each deployment (for example, a software build may be terminated in case of test failures), simulate chaos to detect the robustness of a pipeline, assist data pipeline owners in testing for edge cases with “dirty” data, or the like.

The data anomaly configuration 130 being based on one or more generative AI prompts may help to improve accessibility of the data anomaly generation system 110 for audiences with a stake in data correctness and robust testing having limited technical background.

Outputting the output dataset based on the generative AI model may help to produce anomalies with high fidelity to real data (e.g., non-test data, such as data that the software system will encounter post-release).

FIG. 8 is a diagram of an example environment 800 in which systems and/or methods described herein may be implemented. As shown in FIG. 8, environment 800 may include a data anomaly generation system 801, which may include one or more elements of and/or may execute within a cloud computing system 802. The cloud computing system 802 may include one or more elements 803-812, as described in more detail below. As further shown in FIG. 8, environment 800 may include a network 820 and/or a user device 830. Devices and/or elements of environment 800 may interconnect via wired connections and/or wireless connections.

The cloud computing system 802 may include computing hardware 803, a resource management component 804, a host operating system (OS) 805, and/or one or more virtual computing systems 806. The cloud computing system 802 may execute on, for example, an Amazon Web Services platform, a Microsoft Azure platform, or a Snowflake platform. The resource management component 804 may perform virtualization (e.g., abstraction) of computing hardware 803 to create the one or more virtual computing systems 806. Using virtualization, the resource management component 804 enables a single computing device (e.g., a computer or a server) to operate like multiple computing devices, such as by creating multiple isolated virtual computing systems 806 from computing hardware 803 of the single computing device. In this way, computing hardware 803 can operate more efficiently, with lower power consumption, higher reliability, higher availability, higher utilization, greater flexibility, and lower cost than using separate computing devices.

The computing hardware 803 may include hardware and corresponding resources from one or more computing devices. For example, computing hardware 803 may include hardware from a single computing device (e.g., a single server) or from multiple computing devices (e.g., multiple servers), such as multiple computing devices in one or more data centers. As shown, computing hardware 803 may include one or more processors 807, one or more memories 808, and/or one or more networking components 809. Examples of a processor, a memory, and a networking component (e.g., a communication component) are described elsewhere herein.

The resource management component 804 may include a virtualization application (e.g., executing on hardware, such as computing hardware 803) capable of virtualizing computing hardware 803 to start, stop, and/or manage one or more virtual computing systems 806. For example, the resource management component 804 may include a hypervisor (e.g., a bare-metal or Type 1 hypervisor, a hosted or Type 2 hypervisor, or another type of hypervisor) or a virtual machine monitor, such as when the virtual computing systems 806 are virtual machines 810. Additionally, or alternatively, the resource management component 804 may include a container manager, such as when the virtual computing systems 806 are containers 811. In some implementations, the resource management component 804 executes within and/or in coordination with a host operating system 805.

A virtual computing system 806 may include a virtual environment that enables cloud-based execution of operations and/or processes described herein using computing hardware 803. As shown, a virtual computing system 806 may include a virtual machine 810, a container 811, or a hybrid environment 812 that includes a virtual machine and a container, among other examples. A virtual computing system 806 may execute one or more applications using a file system that includes binary files, software libraries, and/or other resources required to execute applications on a guest operating system (e.g., within the virtual computing system 806) or the host operating system 805.

Although the data anomaly generation system 801 may include one or more elements 803-812 of the cloud computing system 802, may execute within the cloud computing system 802, and/or may be hosted within the cloud computing system 802, in some implementations, the data anomaly generation system 801 may not be cloud-based (e.g., may be implemented outside of a cloud computing system) or may be partially cloud-based. For example, the data anomaly generation system 801 may include one or more devices that are not part of the cloud computing system 802, such as device 900 of FIG. 9, which may include a standalone server or another type of computing device. The data anomaly generation system 801 may perform one or more operations and/or processes described in more detail elsewhere herein.

The network 820 may include one or more wired and/or wireless networks. For example, the network 820 may include a cellular network, a public land mobile network (PLMN), a local area network (LAN), a wide area network (WAN), a private network, the Internet, and/or a combination of these or other types of networks. The network 820 enables communication among the devices of the environment 800.

The user device 830 may include one or more devices capable of receiving, generating, storing, processing, and/or providing information associated with data anomaly generation, as described elsewhere herein. The user device 830 may include a communication device and/or a computing device. For example, the user device 830 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. The user device 830 may enable a user to interact with the data anomaly generation system 801 (e.g., via a CLI). For example, the user device 830 may enable the user to indicate the data anomaly configuration 130, view the output dataset 170, or the like.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of the environment 800 may perform one or more functions described as being performed by another set of devices of the environment 800.

FIG. 9 is a diagram of example components of a device 900 associated with data anomaly generation. The device 900 may correspond to the data anomaly generation system 801 and/or the user device 830. In some implementations, data anomaly generation system 801 and/or the user device 830 may include one or more devices 900 and/or one or more components of the device 900. As shown in FIG. 9, the device 900 may include a bus 910, a processor 920, a memory 930, an input component 940, an output component 950, and/or a communication component 960.

The bus 910 may include one or more components that enable wired and/or wireless communication among the components of the device 900. The bus 910 may couple together two or more components of FIG. 9, such as via operative coupling, communicative coupling, electronic coupling, and/or electric coupling. For example, the bus 910 may include an electrical connection (e.g., a wire, a trace, and/or a lead) and/or a wireless bus. The processor 920 may include a central processing unit, a graphics processing unit, a microprocessor, a controller, a microcontroller, a digital signal processor, a field-programmable gate array, an application-specific integrated circuit, and/or another type of processing component. The processor 920 may be implemented in hardware, firmware, or a combination of hardware and software. In some implementations, the processor 920 may include one or more processors capable of being programmed to perform one or more operations or processes described elsewhere herein.

The memory 930 may include volatile and/or nonvolatile memory. For example, the memory 930 may include random access memory (RAM), read only memory (ROM), a hard disk drive, and/or another type of memory (e.g., a flash memory, a magnetic memory, and/or an optical memory). The memory 930 may include internal memory (e.g., RAM, ROM, or a hard disk drive) and/or removable memory (e.g., removable via a universal serial bus connection). The memory 930 may be a non-transitory computer-readable medium. The memory 930 may store information, one or more instructions, and/or software (e.g., one or more software applications) related to the operation of the device 900. In some implementations, the memory 930 may include one or more memories that are coupled (e.g., communicatively coupled) to one or more processors (e.g., processor 920), such as via the bus 910. Communicative coupling between a processor 920 and a memory 930 may enable the processor 920 to read and/or process information stored in the memory 930 and/or to store information in the memory 930.

The input component 940 may enable the device 900 to receive input, such as user input and/or sensed input. For example, the input component 940 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 950 may enable the device 900 to provide output, such as via a display, a speaker, and/or a light-emitting diode. The communication component 960 may enable the device 900 to communicate with other devices via a wired connection and/or a wireless connection. For example, the communication component 960 may include a receiver, a transmitter, a transceiver, a modem, a network interface card, and/or an antenna.

The device 900 may perform one or more operations or processes described herein. For example, a non-transitory computer-readable medium (e.g., memory 930) may store a set of instructions (e.g., one or more instructions or code) for execution by the processor 920. The processor 920 may execute the set of instructions to perform one or more operations or processes described herein. In some implementations, execution of the set of instructions, by one or more processors 920, causes the one or more processors 920 and/or the device 900 to perform one or more operations or processes described herein. In some implementations, hardwired circuitry may be used instead of or in combination with the instructions to perform one or more operations or processes described herein. Additionally, or alternatively, the processor 920 may be configured to perform one or more operations or processes described herein. Thus, implementations described herein are not limited to any specific combination of hardware circuitry and software.

The number and arrangement of components shown in FIG. 9 are provided as an example. The device 900 may include additional components, fewer components, different components, or differently arranged components than those shown in FIG. 9. Additionally, or alternatively, a set of components (e.g., one or more components) of the device 900 may perform one or more functions described as being performed by another set of components of the device 900.

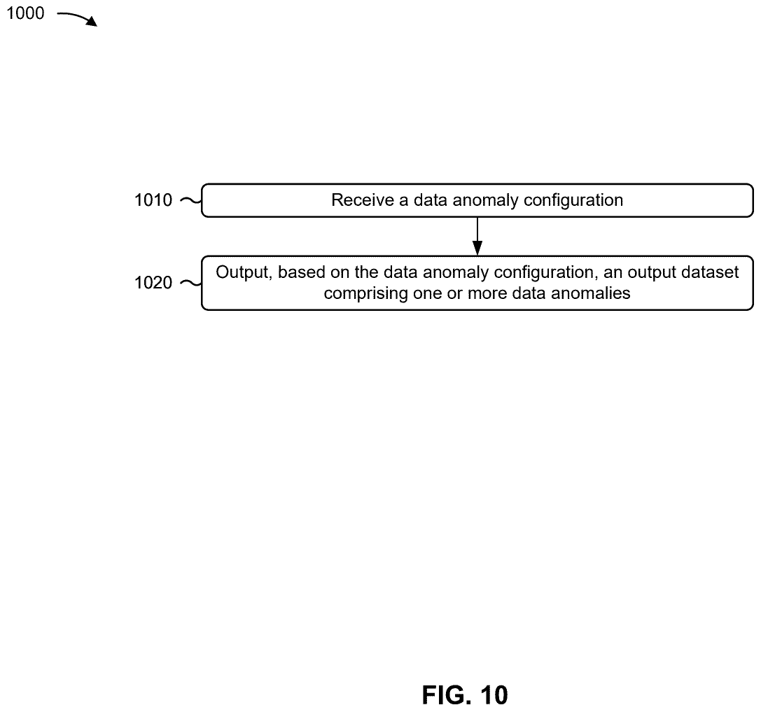

FIG. 10 is a flowchart of an example process 1000 associated with data anomaly generation. In some implementations, one or more process blocks of FIG. 10 may be performed by the data anomaly generation system 801. In some implementations, one or more process blocks of FIG. 10 may be performed by another device or a group of devices separate from or including the data anomaly generation system 801, such as the user device 830. Additionally, or alternatively, one or more process blocks of FIG. 10 may be performed by one or more components of the device 900, such as processor 920, memory 930, input component 940, output component 950, and/or communication component 960.

As shown in FIG. 10, process 1000 may include receiving a data anomaly configuration (block 1010). For example, the data anomaly generation system 801 (e.g., using processor 920, memory 930, input component 940, and/or communication component 960) may receive a data anomaly configuration, as described above in connection with reference number 120 of FIG. 1. As an example, the data anomaly configuration 130 may configure adding a column to the input dataset 150 and/or control with columns in the input dataset 150 are to be modified.

As further shown in FIG. 10, process 1000 may include outputting, based on the data anomaly configuration, an output dataset comprising one or more data anomalies (block 1020). For example, the data anomaly generation system 801 (e.g., using processor 920, memory 930, and/or output component 950) may output, based on the data anomaly configuration, an output dataset comprising one or more data anomalies, as described above in connection with reference number 160 of FIG. 1. As an example, the data anomaly generation system 110 may introduce data chaos in the output dataset 170 by generating column-level anomalies, such as by adding a new column in the output dataset 170.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel. The process 1000 is an example of one process that may be performed by one or more devices described herein. These one or more devices may perform one or more other processes based on operations described herein, such as the operations described in connection with FIGS. 1-7. Moreover, while the process 1000 has been described in relation to the devices and components of the preceding figures, the process 1000 can be performed using alternative, additional, or fewer devices and/or components. Thus, the process 1000 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for data anomaly generation, the system comprising:
one or more memories; and
one or more processors, communicatively coupled to the one or more memories, configured to:
receive a data anomaly configuration;
receive an input dataset; and
output, based on the data anomaly configuration and the input dataset, an output test dataset comprising one or more data anomalies.

2. The system of claim 1, wherein the one or more data anomalies include one or more data type anomalies.

3. The system of claim 1, wherein the one or more data anomalies include one or more data padding anomalies.

4. The system of claim 1, wherein the one or more data anomalies are associated with one or more enumerated values.

5. The system of claim 1, wherein the one or more data anomalies are associated with one or more value ranges.

6. The system of claim 1, wherein the one or more data anomalies include one or more time zone data anomalies.

7. A method of data anomaly generation, comprising:
receiving a data anomaly configuration; and
outputting, based on the data anomaly configuration, an output dataset comprising one or more data anomalies.

8. The method of claim 7, further comprising:
receiving an input dataset, wherein outputting the output dataset includes outputting the output dataset based on the input dataset.

9. The method of claim 7, wherein outputting the output dataset includes generating the output dataset.

10. The method of claim 7, wherein the data anomaly configuration is based on one or more generative artificial intelligence prompts.

11. The method of claim 7, wherein the data anomaly configuration comprises a data anomaly selection configuration, and wherein outputting the output dataset includes outputting the output dataset based on the data anomaly selection configuration.

12. The method of claim 7, wherein outputting the output dataset includes outputting the output dataset based on a generative artificial intelligence model.

13. The method of claim 7, wherein the one or more data anomalies include one or more of:
one or more data type anomalies,
one or more data padding anomalies,
one or more data anomalies associated with one or more enumerated values,
one or more data anomalies associated with one or more value ranges, or
one or more time zone data anomalies.

14. The method of claim 7, wherein the output dataset comprises an output test dataset.

15. A non-transitory computer-readable medium storing a set of instructions, the set of instructions comprising:
one or more instructions that, when executed by one or more processors of a device, cause the device to:
receive a data anomaly configuration; and
output, based on the data anomaly configuration, an output test dataset comprising one or more data anomalies.

16. The non-transitory computer-readable medium of claim 15, wherein the one or more data anomalies include one or more data type anomalies.

17. The non-transitory computer-readable medium of claim 15, wherein the one or more data anomalies include one or more data padding anomalies.

18. The non-transitory computer-readable medium of claim 15, wherein the one or more data anomalies are associated with one or more enumerated values.

19. The non-transitory computer-readable medium of claim 15, wherein the one or more data anomalies are associated with one or more value ranges.

20. The non-transitory computer-readable medium of claim 15, wherein the data anomaly configuration configures one or more data anomaly parameters of the output test dataset.
